(19) United States
(12) Patent Application Publication
(10) Pub. No.: US 2006/0095857 A1
(43) Pub. Date: May 4, 2006

(54) System, apparatus, and method for a singularity based user interface

(76) Inventor: Marko M. Torvinen, Espoo (FI)

Correspondence Address: Hollingsworth & Funk, LLC;Suite 125, 8009 34th Avenue South, Minneapolis, MN, 55425, US

(21) Appl. No.: 10/977,361

(22) Filed: Oct. 29, 2004

(51) Int. Cl. G06F 9/00; G06F 3/00

(52) U.S. Cl. 715/764; 715/835; 715/963

(57) ABSTRACT

A system, apparatus, and method for projecting data onto a terminal display having a multitude of visual queues to enhance the data content projected by the display of the terminal. A multi-dimensional display renders data relative to temporal and priority axes that reflects the relevancy of the data and inter-relationship of the individual data items. Each of the individual data items may exist in a linked, hierarchical relationship with other data items to facilitate viewing from a reduced size display.

### FIELD OF THE INVENTION

This invention relates in general to user interfaces, and more particularly to the arrangement and perception of data that is displayed on the user interfaces.

### BACKGROUND OF THE INVENTION

The proliferation of technology within the computing industry has been due in large part to the consumer's need for faster processors, more memory, faster network access, enhanced mobility, etc. In most respects, technological developments have been able to answer the challenge presented by today's sophisticated consumer. For example, a typical amount of Random Access Memory (RAM) within a 1980's desktop computer may have been on the order of kilobytes (kB), which was adequate to support the primitive applications required by the consumer during that era. Today, however, a typical desktop computer's RAM capability may be on the order of gigabytes (GB), due in large part to the memory requirements of today's high end consumer applications. In just two decades, therefore, technological developments in memory cell processing have facilitated six orders of magnitude improvement in desktop computer RAM capacity.

As the computational and storage capabilities of today's computing devices continues to grow, however, the relative amount of information that may be displayed to the consumer continues to shrink, since the computer's display area that is used to visually present the information is not growing at the same rate. In fact, one of the scarcest computing resources today is display area, which is exacerbated by the fact that today's computers are increasingly networked. Networking allows access to a virtually limitless number of files on the Internet, thus making information arrangement and perception even more challenging.

The display area problem is even more evident as computational environments migrate to portable electronic devices such as Personal Digital Assistants (PDAs), cellular telephones, two-way pagers, and wireless WEB browsers. Such devices have display areas that are many times smaller than their desktop counterparts, and yet are more extensively being utilized for the visual delivery of data, such as HyperText Markup Language (HTML) content, streaming video, etc.

Additionally, as the portable electronic devices become increasingly capable through technological advancement, they are rapidly becoming replacements for desktop computers. As such, they are called upon to store large amounts of business-critical information such as contact lists, memos, business contracts, email, text messaging, to-do lists, etc. Organizing, arranging, and perceiving this business-critical information, therefore, is becoming more of a problem. The personal lives of today's consumers are becoming more complicated as well, which similarly requires the organization and presentation of large amounts of information.

Prior art solutions to visual data organization have generally focused on one of three methods: 1) reducing the number of objects that are visible at one time; 2) increasing the physical size of the display; or 3) increasing the virtual display space within the computing device itself. Various methods of increasing the virtual display space in accordance with method 3) include a zooming model, whereby the user may control the number of objects that are visible on the screen by zooming the whole display in and out. Other methods involve utilizing the concept of an infinitely large virtual display, whereby the user scrolls a viewing window across the two-dimensional display space and is able to view all objects that fall within the viewing window as it is being panned left, right, upward, or downward.

An alternate method of organizing data provides an unlimited, two-dimensional virtual space that is able to store all types of data objects typically found on computer screens, such as icons, pictures, graphical elements, text, etc. In the middle of the display exists a sink, which serves as an unlimited size storage container where objects may be stored when compressed. While in compress mode, objects migrate toward the sink until they vanish from the screen. Conversely, while in expand mode, previously vanished items emerge and migrate away from the sink. Thus, a one-dimensional navigation operation is used to organize data objects in a temporal space, where objects closer to the sink are older than those objects further away from the sink.

Such a presentation system, however, has associated limitations that are a result of the one-dimensional nature of organization. That is to say that a single sink only provides categorization along one dimension, i.e., time, and does not lend itself to multi-dimensional growth due to its single dimensional limitations. Similarly, the ability to adaptively change the implicit notion of the sink, i.e., the temporal implications of the relative object positions with respect to the sink, are fixed. That is to say, that only singular meaning is given to the relative positions of the objects to the sink, which unduly restricts the amount of information that may possibly be displayed.

Accordingly, there is a need in the communications industry for a system, apparatus, and method that enables flexible arrangement of a large amount of data to a terminal display. The arrangement, through the structure of the display and the positioning of items on the display, should be able to reflect multidimensional information about the items on the display.

### SUMMARY OF THE INVENTION

To overcome limitations in the prior art, and to overcome other limitations that will become apparent upon reading and understanding the present specification, the present invention discloses a system, apparatus, and method for arranging and conveying relevant data on a user interface.

In accordance with one embodiment of the invention, a method is provided for placing data objects onto a display. The method comprises extending a first axis along a diagonal portion of the display, extending a second axis along an orthogonal portion relative to the first axis, associating first and second data characteristics with the first and second axis, and locating the data objects on the display. The placement of the data objects relative to the position of the first and second axis is indicative of the data objects' relationship to the first and second data characteristic.

In accordance with another embodiment of the invention, a user interface of a mobile terminal's display is capable of portraying a plurality of characteristics associated with data objects appearing on the user interface. The user interface comprises a first axis extended along a first portion of the user interface to connote a first configurable characteristic, a second axis extended along a second portion of the user interface to connote a second configurable characteristic, and at least one data object displayed on the user interface. A position of the data object portrays a level of association between the data object and the first and second configurable characteristics.

In accordance with another embodiment of the invention, a data organization system comprises a plurality of data sources containing data files and a mobile terminal that is wirelessly coupled to the data sources and is adapted to visually display representations of the data files contained within the data sources in accordance with configurable organization criteria. The mobile terminal has a user interface that comprises a tab that is indicative of a category of data files displayed by the user interface, a first axis extended along a first portion of the user interface to connote a first configurable characteristic, a second axis extended along a second portion of the user interface to connote a second configurable characteristic, and a plurality of icons representative of the data files each associated with the data category indicated by the tab. A position of the plurality of icons portrays a level of association between the plurality of icons and the first and second configurable characteristic.

In accordance with another embodiment of the invention, a computer-readable medium containing instructions are executable by a mobile terminal for placing data objects onto a display of the mobile terminal. The instructions perform steps that comprise extending a first axis along a diagonal portion of the display, extending a second axis along an orthogonal portion relative to the first axis, associating first and second data characteristics with the first and second axis, and locating the data objects on the display. The placement of the data objects relative to the position of the first and second axis is indicative of the data objects' relationship to the first and second data characteristic.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

The invention is described in connection with the embodiments illustrated in the following diagrams.

FIG. 1 illustrates a user interface in accordance with the present invention;

FIG. 2 illustrates an exemplary presentation in accordance with the present invention;

FIG. 3 illustrates exemplary information sources supplying information to the user interface of the present invention;

FIG. 4 illustrates an exemplary embodiment of a user interface in accordance with the present invention;

FIG. 5 illustrates an exemplary user interface presentation in accordance with the present invention; and

FIG. 6 illustrates a representative mobile computing arrangement suitable for displaying data in accordance with the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system, apparatus, and method that provides a new user interface type that enables increased flexibility for business and personal information organization scenarios, where information is organized within the user interface in accordance with a virtually unlimited set of configurable dimensions. Information, for example, may be organized along axes of the user interface in accordance with a relative time perspective, e.g., past, present, future. Alternately, information may be emphasized according to other dimensions such as priority, task completeness, or relationship to other items. In addition, data segmentation on the display screen may take place in accordance with the data's particular class association, such as data segmentation of the user's to-do list based on priority, or conversely, data segmentation based on text messages that are displayed in chronological order.

Data types, such as word documents or spread sheet documents, having both a temporal identity as well as a typographical identity, may be arranged according to both identities simultaneously. That is to say, that data segmentation on the display screen may first categorize the documents as being either word documents or spread sheet documents. Next, the categorized documents may then be displayed sequentially according to their creation time stamp along a temporal axis that extends, for example, from past to present. A third dimension of organization may also be incorporated to visually relate the priority levels of the various documents along a priority axis that extends, for example, from low to high priority, along an orthogonal line relative to the temporal axis.

The user interface in accordance with the present invention finds application in a number of usage scenarios as will be discussed in more detail below. The user interface, for example, is applicable in a personal mode, whereby the user's personal calendar, personal data, and personal applications may be organized relative to time, classification type, priority, or any number of other dimensions. Likewise, the user may apply the user interface within his or her mobile office environment, whereby project schedules, meeting agendas, to-do lists, and the like may be similarly organized.

The user interface in accordance with the present invention presents information along one or more axes, whereby a first axis may present information according to a first dimension, e.g., using a temporal reference, while a second axis aligns the same information according to a second dimension, e.g., using a relative priority. In such an instance, each axis is arranged according to a virtual singularity, where the singularity is representative of a pseudohorizon, existing for both ends of the one or more axis.

On one end of a temporal axis, for example, a “future” singularity may exist, which extends into the future along a configurable quantum of time relative to a temporal reference point, e.g., the current time and/or date. Similarly, a “past” singularity may exist at the opposite end, which extends into the past along a configurable quantum of time that may also be relative to the reference point. The axis extending between each of the temporal singularities may be partitioned into sub-axes, each partition being defined through the use of orthogonal markers to present a more accurate representation of the temporal granularity along the axis.

If a second axis is activated on the user interface, e.g., a priority axis, then a second set of singularities are contemplated, whereby a “lowest priority” singularity exists, for example, at one end of the priority axis and a “highest priority” singularity exists, for example, at the other end. Items presented on the user interface that are in close proximity to the priority axis may then be understood to have, for example, a greater priority than those items presented on the user interface that are relatively further away from the priority axis. In such a way, not only is the consumer of the user interface able to glean the relative temporal relationship existing between all elements presented along the temporal axis, but the consumer is also able to glean the relative importance of each element presented along the priority axis.

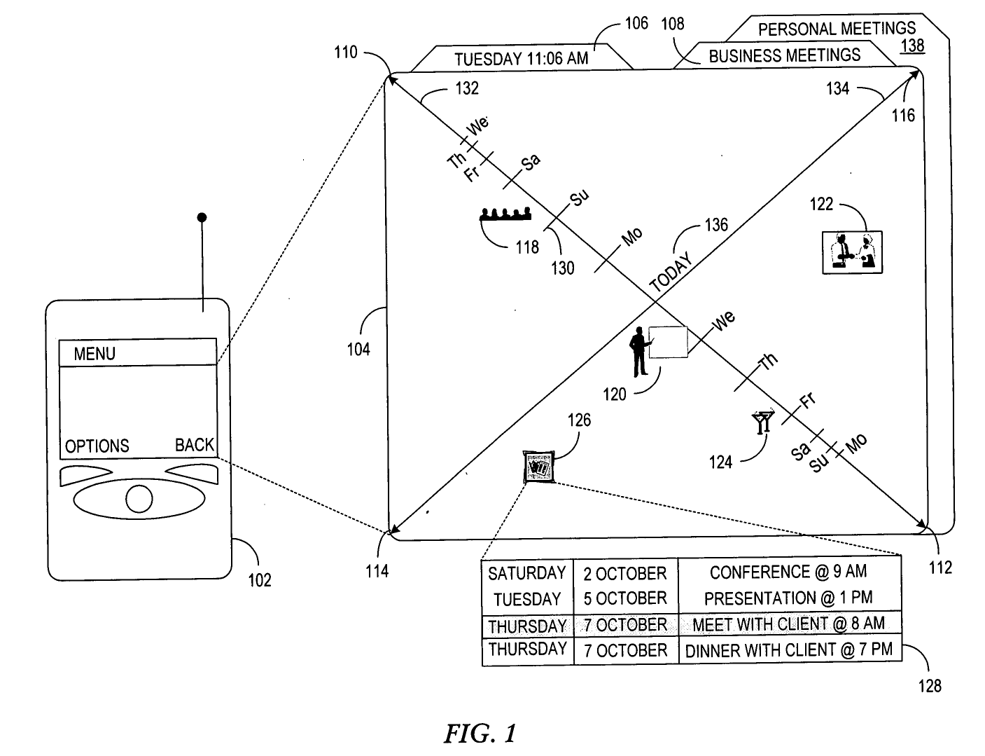

In accordance with one embodiment of the present invention, user interface 104 exhibiting a dual axis is exemplified in FIG. 1, whereby axis 132 is arranged by virtual singularities representative of time, and axis 134 is arranged by virtual singularities representative of priority. Although user interface 104 is exemplified for use with mobile terminal 102, one of ordinary skill in the art will recognize that user interface 104 is available for use on virtually any device having a visual display including PDAs, cellular telephones, two-way pagers, wireless WEB browsers, and desktop computers to name only a few.

At the upper left hand corner of user interface 104, one of two temporal pseudohorizons corresponding to past singularity 110 is presented on temporal axis 132. Moving along temporal axis 132 from the reference point, e.g., today marker 136, toward past singularity 110 denotes a movement that starts from current day 136, as well as current time 106, and extends to points in time that represent the past. Sunday 130, for example, provides an orthogonal marker that allows the user to easily gain perspective as to the duration of temporal axis 132 as it relates to past events relative to current date 136, e.g., Tuesday the 5^{th} of October.

For example, icon 118 may indicate that a conference was held at some point in the past relative to current date 136. Counting the number of orthogonal markers that intersect temporal axis 132 from current date 136 to the date marker that corresponds to icon 118, the user easily calculates that the conference relating to icon 118 took place 3 days prior to current date 136. While the number of orthogonal markers existent along temporal axis 132 is configurable, it can be seen that events occurring approximately one week in the past are displayed relative to current date 136.

To further enhance the readability of user interface 104, orthogonal markers 130 may be spaced along temporal axis 132 in a non-linear fashion. That is to say, for example, that the sub-axial distances defined by the orthogonal markers for the three days just prior to current date 136 (e.g., Monday, Sunday, and Saturday) may be equidistant, whereas the sub-axial distances defined by the orthogonal markers for the preceding three days (e.g., Friday, Thursday, and Wednesday) may be spaced at decreasing distances. In such a way, therefore, presentation of past events occurring closer in time to current date 136 appear to be enhanced, or magnified, as compared to those events occurring further in the past, i.e., closer to past singularity 110.

At the lower right hand corner of user interface 104, the second of two temporal pseudohorizons corresponding to future singularity 112 is presented on temporal axis 132. Moving along temporal axis 132 from the reference point, e.g., today marker 136, toward future singularity 112 denotes a movement that starts from current day 136, as well as current time 106, and extends to points in time that represent the future. Similarly, orthogonal markers placed along temporal axis 132 allows the user to easily gain perspective as to the duration of temporal axis 132 as it relates to future events relative to current date 136, e.g., Tuesday the 5^{th} of October.

To further enhance the readability of user interface 104, orthogonal markers may be spaced along temporal axis 132 in a similar non-linear fashion. That is to say, for example, that the sub-axial distances defined by the orthogonal markers for the three days just after current date 136 (e.g., Wednesday, Thursday, and Friday) may be equidistant, whereas the sub-axial distances defined by the orthogonal markers for the next three days (e.g., Saturday, Sunday, and Monday) may be spaced at decreasing distances. In such a way, therefore, presentation of future events occurring closer in time to current date 136 appear to be enhanced, or magnified, as compared to those events occurring further in the future, i.e., closer to future singularity 112.

A second axis, e.g., priority axis 134, may also be displayed by user interface 104 to allow the user to gain priority information relating to icons 118-124 at a glance. That is to say, for example, that icons placed in closer proximity to high priority singularity 116 may be considered to be at a higher priority as compared to those icons placed in closer proximity to low priority singularity 114. Taking user interface 104 as an example, the single most important meeting that corresponds to business meetings tab 108 as displayed by user interface 104 is represented by client meeting 122, which is scheduled to occur on Thursday, 7 October. The relative importance of client meeting 122 is easily ascertained visually, since its position relative to icons 118, 120, and 124 is closer to high priority singularity 116. Similarly, it can be seen that the relative importance of conference 118, presentation 120, and client dinner 124 are about equal, since they exist at relatively equal positions relative to priority axis 134.

Priority axis 134 may also connote a secondary meaning in addition to its priority inference. That is to say, for example, that priority axis 134 may be constantly repositioned to denote the reference point, e.g., the current date. As illustrated, priority axis 134 is positioned along a center diagonal that coincides with current date 136, e.g., Tuesday, 5 October. On the next day, current date 136 is incremented by one day, such that current date 136 becomes Wednesday, 6 October. On the following day, current date 136 is incremented by one day, such that current date 136 becomes Thursday, 7 October, and so on.

Likewise, priority axis 134 may also be repositioned in accordance with the particular time of the reference point. For example, priority axis 134 may be positioned such that the current date is Tuesday, 5 October, while also displaying a visual representation of the current time, e.g., 11:06 am. Thus, as the scheduled time of presentation 120, for example, becomes closer in time to the current time, the position of priority axis 134 may be adjusted along temporal axis 132, such that the relative position of priority axis 134 is closer to presentation icon 120. Alternately, instead of sliding priority axis 134 closer to presentation icon 120, presentation icon 120 may be moved closer to priority axis 134 as time goes on, while icons 118, and 122-136 are also appropriately moved in relation to priority axis 134 as well. Either way, it can be seen that the user is provided with a visual representation of the amount of time remaining between current time 106 and the scheduled time of presentation 120. Once the scheduled time for presentation 120 has arrived, priority axis 134 and icon 120 will be shown to intersect one another.

As an additional means of providing the user with visual indicia of looming and/or important events, the relative size of icons 118-124 may be altered as necessary. For example, icons representing events taking place closer in time relative to reference point 106 may appear larger than those icons representing events taking place further in time relative to reference point 106. Similarly, icons representing events whose priority is high may appear larger than those icons representing events whose priority is low.

Generally speaking, therefore, those icons placed in the upper right hand hemisphere (e.g., high priority events) may exhibit a larger size as those icons that are placed in the lower left hand hemisphere (e.g., low priority events). Similarly, those icons placed in the lower right hand hemisphere (e.g., future events) that are also closer to priority axis 134 (e.g., looming future events) may exhibit a larger size than those icons placed further away from priority axis 134 (e.g., those events occurring further in the future.)

Using the navigational control inputs existent within mobile terminal 102, the user may select icons 118-126 in order to activate any additional data that may be associated with the selected icon. For example, the user may select icon 122 to activate any data objects that may relate to the client meeting scheduled for 7 October. Selection of icon 122 may, for example, launch an electronic presentation that is to be used to facilitate the client meeting. The electronic presentation may exist locally within mobile terminal 102 or alternatively, HTML links to the electronic presentation file may be used to facilitate network access of the electronic presentation file by mobile terminal 102.

Selection of client meeting icon 122 may also instantiate a work space that relates to client meeting 122. For example, the related work space may provide the user with specified contact/communication possibilities for all participants of the client meeting to include Instant Messaging (IM), email, voice call, and conference call access mechanisms. Additionally, all previous communications/files relating to client meeting 122 may be made available to the user, such as previous email verification of participant attendance at client meeting 122, or prior peer review edits/comments of the electronic presentation file to be used during client meeting 122.

Selection of icon 126 instantiates tabular view 128 that presents the scheduled meetings/events of business meetings tab 108. As illustrated, events are displayed in a chronologically increasing order as they appear along temporal axis 132. It can be seen, however, that tabular view 128 may also be configured to provide information in accordance with increasing priority. In such an instance, client meeting 122 may occupy the first tabular position indicating the highest priority, while the remaining meetings occupy the lower priority tabular positions. In addition, selection of icon 122 may be visually highlighted by displaying a rectangular box around icon 122, while the corresponding selection within tabular display 128 may be shaded as illustrated.

Using the navigational capabilities of mobile terminal 102, the user may also display other meeting views that relate to, for example, personal matters as organized by tab 138. Simply by activating tab 138, the user may view visual information that is similarly organized for all personal matters. It can be seen that business meeting category 108 and personal meeting category 138 may be further sub-divided into meeting data partitions as required. For example, personal meeting category 138 may be further broken down into soccer practice meetings and boating club meetings so that the respective meeting schedules and related priorities may be viewed at a glance.

As will be discussed in more detail below, the number of partitions of data displayed by user interface 104 may also be configurable. That is to say that user interface 104 may be optionally divided into two or more areas in accordance with user configuration. For example, four quadrants may be partitioned and visually displayed to organize data objects into their respective quadrant, where each quadrant may denote a sub-folder of data that is associated with a general category. Where the general category relates to work product of a particular design team, for example, each of the four quadrants may contain data objects that relate to four separate projects that are being executed by the design team. Thus, a four project summary relating to the design team may be individually displayed and organized by the four quadrant display, while simultaneously providing relative time and priority relationships as discussed above in relation to FIG. 1.

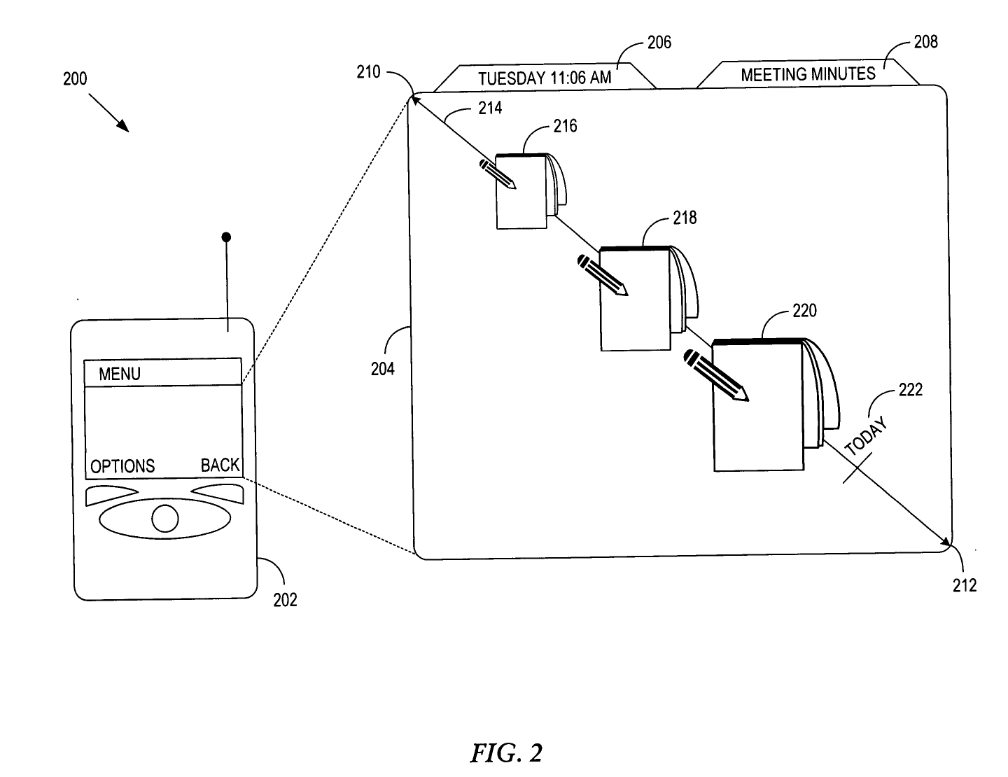

In addition to the number of data partitions that are displayable by user interface 104, user interface 104 may be configurable by the user in many other respects. For example, the span of time indicated by temporal axis 132 indicates a symmetry about current date 136, whereby six days in the future (e.g., toward singularity 112) and six days in the past (e.g., toward singularity 110) are displayed. Other configurations are possible, however, which may be more useful as discussed in more detail in relation to FIG. 2.

Turning to FIG. 2, exemplary presentation 200 in accordance with the present invention is illustrated. Presentation 200 exhibits temporal axis 214 having past singularity 210 and future singularity 212 as described in relation to FIG. 1. As denoted by category tab 208, icons 216-220 presented by user interface 204 of mobile terminal 202 correspond to meeting minutes taken during meetings held at various times in the past. A single orthogonal marker 222 exists to denote the position along temporal axis 214 that relates to the current date. Since icons 216-220 presented by presentation 200 have no particular priority levels associated with them, the user may configure user interface 204 to display only that information that is pertinent to icons 216-220 and no more, e.g., elimination of the priority dimension and the display of only the pertinent temporal characteristics.

For example, since no meetings have been held in the future, there exist no meeting minutes associated with those meetings. Accordingly, temporal axis 214 is skewed such that orthogonal marker 222 denoting the current date and time 206 is moved to the lower right portion of user interface 204 (i.e., closer to future singularity 212), since no future meeting minute icons exist for display. Additionally, icon 220 is rendered to be larger than icons 216-218, in order to denote that the most recent meeting minutes taken are represented by icon 220. Similarly as discussed above in relation to FIG. 1, the user may highlight icon 220 for activation, such that the meeting minute file represented by icon 220 may be opened for edit and review.

Icons 218 and 216 are rendered as diminishingly sized icons, in order to denote their relative creation date with respect to current date marker 222. As such, icon 218 may be visually construed as representative of an older version of meeting minutes with respect to icon 220, but representative of a newer version of meeting minutes as compared to the meeting minutes represented by icon 216. As can be seen, therefore, FIG. 2 exemplifies the configurability of user interface 204 in relation to the data being displayed. Since presentation 200 deals with multiple versions of related data files only, the span of time indicated by temporal axis 214 and the corresponding singularities 210 and 212 represented at each pseudohorizon are the only descriptors necessary to accurately display the amount of visual information necessary.

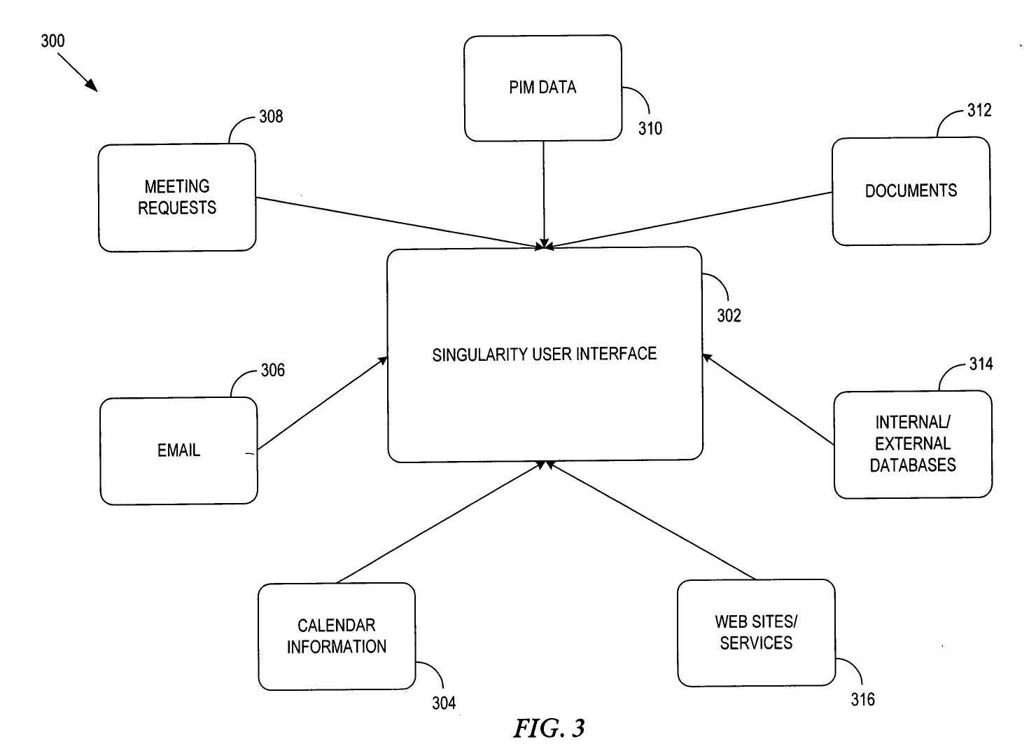

The amount and type of information that may be displayed in accordance with the present invention is virtually unlimited and is directly related to the environment in which the singularity user interface is operating as exemplified by data system 300 of FIG. 3. In particular, the personal and/or work related information items that may be visually organized by singularity user interface 302 is directly proportional to the data access provided by data system 300 to singularity user interface 302.

Data access mechanisms provided by data system 300 may be represented by a combination of all mobile radio standards, such as Global System for Mobile Communications (GSM)/Enhanced Data Rates for Global Evolution (EDGE) and Wideband Code Division Multiple Access (WCDMA). Similarly, short range wireless standards such as Bluetooth and IEEE 802.11, may be utilized by data system 300 to facilitate data transfer to singularity user interface 302 from each of the surrounding data sources 304-316.

Calendar information 304 and meeting requests 308, for example, may provide singularity user interface 302 with both business related and personal related meeting schedule information. The user may select which of the business related or personal related information is to be displayed by making the appropriate selection of tab 108 or 138 of FIG. 1. For example, since tab 108 indicates “business meetings”, all meeting information that is business related is to be displayed by singularity user interface 302. Conversely, selection of personal meetings tab 138 routes all personal calendar information to be displayed by singularity user interface 302. Other information sources, such as email 306, documents 312, internal/external databases 314, Protocol Independent Multicast (PIM) 310, and WEB sites/services 316 may be similarly divided between business related or personal related information. PIM 310 is a scalable, efficient, and robust multicast routing protocol that is capable of supporting thousands of groups, different types of multicast applications, and all major underlying layer-2 subnetwork technologies.

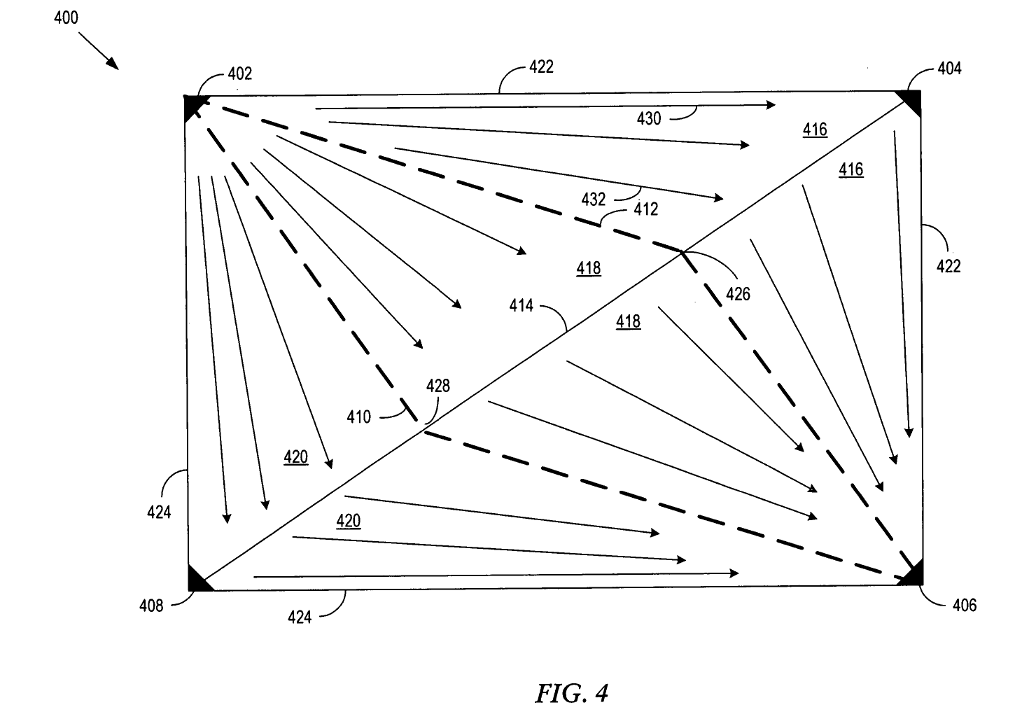

As discussed above, the present invention contemplates the use of configurable data partitions that may be displayed by user interface 104. That is to say that user interface 104 may be optionally divided into three or more areas in accordance with the user configuration as exemplified by tripartite user interface 400 of FIG. 4. In particular, sections 416-420 are partitioned via internal and external segmentation borders 410, 412 and 422, 424, respectively, and visually displayed to organize data objects into their respective section. Each section may denote a sub-folder of data that is associated with a general category. Such a general category may relate to the work product of a particular design team, where for example, each of the three sections 416-420 may contain data objects relating to three separate projects that are being executed by the design team. Thus, a three project summary relating to the design team may be individually displayed and organized by tripartite display 400, while simultaneously providing relative time and priority relationships through ordering the respective icons as indicated by the arrows within each of sections 416-420.

Singularities 402-408 each have their respective temporal and priority based definitions as described in relation to FIG. 1. However, since user interface 400 is a tripartite display, singularities 426 and 428 take on varying definitions depending upon which section is being viewed. In particular, section 416 provides a two-dimensional view having objects displayed in accordance with temporal and priority attributes, where extensions of object placements from singularity 402 to singularity 406 correspond to displays of objects moving from the past to the future, respectively. Object placements closer to border 422 denote higher priority placements as compared to objects placed closer to internal border 412. Singularity 426 corresponds to a low priority singularity when viewed relative to section 416, but corresponds to a high priority singularity when viewed relative to section 418. Similarly, whereas singularity 428 serves as a low priority singularity for section 418, singularity 428 simultaneously serves as a high priority singularity for section 420.

In addition, while singularities 404, 408, 426, and 428 are each identified as “priority” singularities, their meanings can adopt varying connotations of priority. That is to say, for example, that priority for a document may take on meaning in response to its level of completion. Thus, whereas the priority of a particular document may initially receive a low priority rating when displayed, it may nevertheless be promoted in priority if the document's due date continues to move closer, while the level of completion of the document remains the same.

For example, an icon (not shown) representing a low priority document may initially be created with a 20% completion factor and displayed at the intersection of line 432 and present time line 414. As time transpires, however, the icon is displayed at increasing distances from present time line 414 in the direction of past singularity 402, since the document grows increasingly stale. As present time line 414 moves closer to the document's required completion date, the document's priority is then promoted from low priority to high priority since the completion factor remains at 20% while the required completion date looms closer. In such an instance, the icon representative of the document is removed from line 432 and displayed at the intersection of line 430 (i.e., closer to high priority border 422) and present time line 414 to denote the document's elevated priority. The user, having been alerted by the visual priority information presented by tripartite display 400, may then take the necessary action to increase the completion factor from 20% to a more acceptable percentage level. Once completed, the icon may then be redisplayed at a reduced priority (i.e., closer to low priority border 412) that is commensurate with the revised level of completion of its corresponding document.

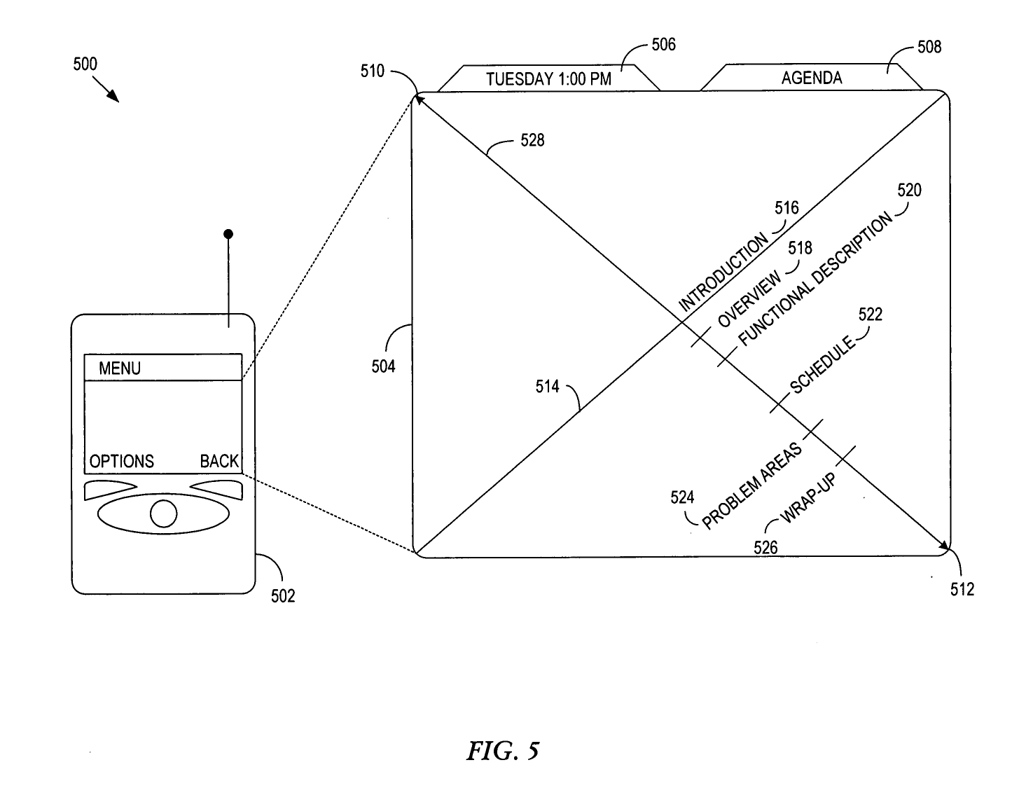

As discussed above in relation to FIG. 1, icons appearing on user interface 104 may be selected and activated via the mobile terminal's navigational capabilities. In accordance with one embodiment of the present invention, activation of a particular icon of display 104 may instantiate another display having a hierarchical relationship to the selected icon. For example, selection of presentation icon 120 may instantiate agenda 500 of FIG. 5, which represents the presentation agenda that is linked to presentation icon 120.

Business meetings tab 108 of FIG. 1, for example, may represent a scheduling utility that is accessible by every employee that is associated with a particular corporation via meeting requests 308 of FIG. 3. Once downloaded into mobile terminal 502, employees wishing to attend presentation 120 may select and activate presentation icon 120 to receive additional information concerning presentation 120. A portion of the additional information may be agenda 504 of FIG. 5, whereby prospective attendees are able to view the agenda in an effort to facilitate their decision to attend. Further, the presentation start time is given by tag 506, which is also effective to set presentation time line 514.

Since there are no events taking place prior to Tuesday at 1:00 pm in relation to the presentation, no events are listed on temporal axis 528 between presentation time line 514 and past singularity 510. Only future events exist prior to Tuesday at 1:00 pm and they are listed along temporal axis 528 toward future singularity 512 as introduction 516, overview 518, functional description 520, schedule 522, problem areas 524, and wrap-up 526. If agenda 500 catches the attention of the user viewing it, the user may then select and activate portions 516-526 of agenda 500 in order to view any other documents that may be linked to those portions.

For example, if the user is a member of the engineering population, he or she may select and activate functional description 520 in order to activate a document that describes in detail the functional description that is the subject of presentation 120. If, on the other hand, the user is a member of the management population, he or she may be more interested in viewing the current schedule 522, or problem areas 524, that are associated with the subject of presentation 120. The linked documents may themselves incorporate links to other documents thereby creating a hierarchy of documentation associated with presentation 120.

The present invention thus enables a larger amount of data to be viewed by either a mobile terminal or a fixed terminal than was previously possible. In addition, visual queues allow perception of displayed data within a multitude of contexts, which adds another dimension to the information that is communicated by the user interface in accordance with the present invention. Still further, the present invention enables a more flexible user interface that simplifies usage on a smaller display while maintaining the intuitiveness of a larger display. Furthermore, the structure of the display and the positioning of the data on the display helps to reflect the relevancy of each data item and the relationship shared between each data item.

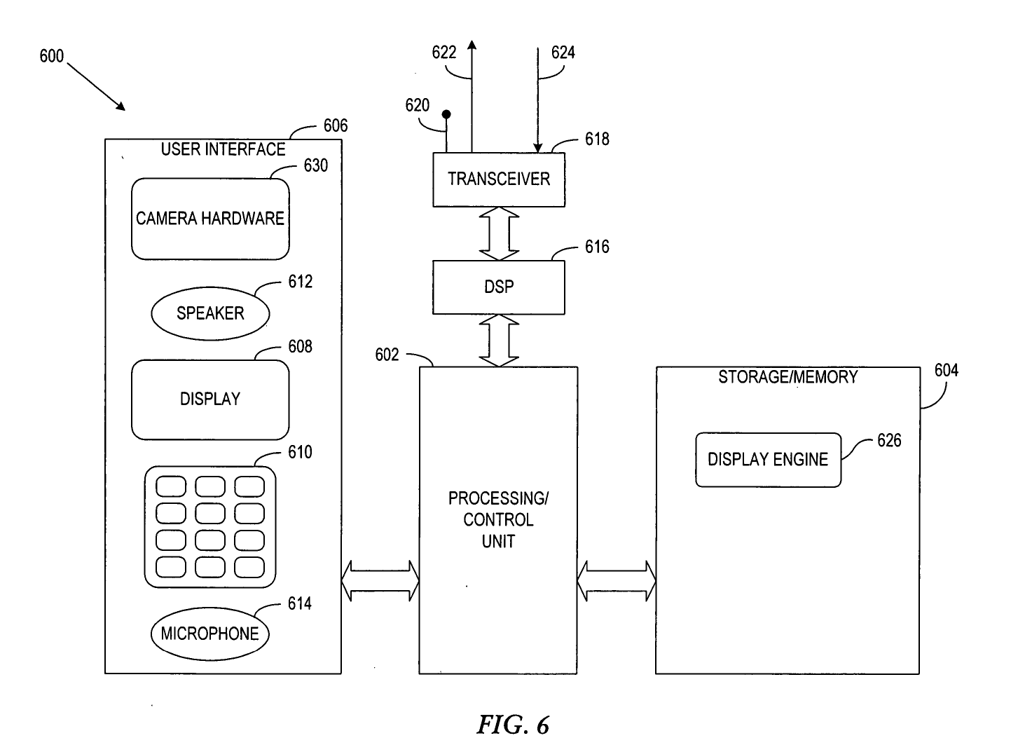

The invention is a modular invention, whereby processing functions within either a mobile terminal or a fixed terminal may be utilized to implement the present invention. The mobile devices may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various display functions described herein. An example of a representative mobile terminal computing system capable of carrying out operations in accordance with the invention is illustrated in FIG. 6. Those skilled in the art will appreciate that the exemplary mobile computing environment 600 is merely representative of general functions that may be associated with such mobile devices, and also that landline computing systems similarly include computing circuitry to perform such operations.

The exemplary mobile computing arrangement 600 suitable for facilitating display functions in accordance with the present invention may be associated with a number of different types of wireless devices. The representative mobile computing arrangement 600 includes a processing/control unit 602, such as a microprocessor, reduced instruction set computer (RISC), or other central processing module. The processing unit 602 need not be a single device, and may include one or more processors. For example, the processing unit may include a master processor and associated slave processors coupled to communicate with the master processor.

The processing unit 602 controls the basic functions of the mobile terminal, and also those functions associated with the present invention as dictated by display engine 626 available in the program storage/memory 604. Thus, the processing unit 602 is capable of accessing presentation content and placing it onto display 608 using display engine 626 in accordance with the singularity user interface definitions disclosed herein. The program storage/memory 604 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 604 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 600 via data signals, such as being downloaded electronically via one or more networks, such as the Internet and an intermediate wireless network(s).

The processor 602 is also coupled to user-interface 606 elements associated with the mobile terminal. The user-interface 606 of the mobile terminal may include, for example, a display 608 such as a liquid crystal display, a keypad 610, speaker 612, and microphone 614. These and other user-interface components are coupled to the processor 602 as is known in the art. Other user-interface mechanisms may be employed, such as voice commands, switches, touch pad/screen, graphical user interface using a pointing device, trackball, joystick, or any other user interface mechanism.

The mobile computing arrangement 600 also includes conventional circuitry for performing wireless transmissions. A digital signal processor (DSP) 616 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 618, generally coupled to an antenna 620, transmits the outgoing radio signals 622 and receives the incoming radio signals 624 associated with the wireless device.

The mobile computing arrangement 600 of FIG. 6 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a singularity user interface display system, apparatus, and method in accordance with the present invention.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

What is claimed is:

1. A method for placing data objects onto a display, comprising:
extending a first axis along a diagonal portion of the display;
extending a second axis along an orthogonal portion relative to the first axis;
associating first and second data characteristics with the first and second axis; and
locating the data objects on the display, wherein placement of the data objects relative to the position of the first and second axis is indicative of the data objects' relationship to the first and second data characteristic.

2. The method according to claim 1, wherein extending the first axis comprises establishing a pseudohorizon at each end of the first axis.

3. The method according to claim 2, wherein establishing the pseudohorizon comprises relating a first end of the first axis to a temporal extremity indicative of a point in the past relative to a first reference point located on the first axis.

4. The method according to claim 3, wherein establishing the pseudohorizon further comprises relating a second end of the first axis to a temporal extremity indicative of a point in the future relative to the first reference point located on the first axis.

5. The method according to claim 4, further comprising segmenting the first axis into sub-axes.

6. The method according to claim 5, wherein segmenting the first axis comprises allocating equal portions of time to a portion of the sub-axes.

7. The method according to claim 6, wherein the sub-axes allocated with equal portions of time are located closest to the first reference point.

8. The method according to claim 1, wherein extending the second axis comprises establishing a pseudohorizon at each end of the second axis.

9. The method according to claim 8, wherein establishing the pseudohorizon comprises relating a first end of the second axis to a low priority extremity relative to a second reference point located on the second axis.

10. The method according to claim 9, wherein establishing the pseudohorizon further comprises relating a second end of the second axis to a high priority extremity relative to the second reference point located on the second axis.

11. The method according to claim 10, wherein data objects having a higher priority relative to data objects having a lower priority are placed closer to the high priority extremity.

12. The method according to claim 11, wherein locating the data objects comprises representing the data objects as icons having a particular size, the higher priority icons being larger than the lower priority icons.

13. On a display of a mobile terminal, a user interface capable of portraying a plurality of characteristics associated with data objects appearing on the user interface, the user interface comprising:
a first axis extended along a first portion of the user interface to connote a first configurable characteristic;
a second axis extended along a second portion of the user interface to connote a second configurable characteristic; and
at least one data object displayed on the user interface, wherein a position of the data object portrays a level of association between the data object and the first and second configurable characteristics.

14. The user interface of claim 13, wherein the first configurable characteristic is indicative of time.

15. The user interface according to claim 14, wherein a first end of the first axis denotes a time in the past.

16. The user interface according to claim 15, wherein a second end of the first axis denotes a time in the future.

17. The user interface according to claim 16, wherein the position of the data object relative to the first axis visually indicates a time stamp associated with the data object.

18. The user interface according to claim 17, wherein data objects having a time stamp nearer in time relative to a reference point appear larger than data objects having a time stamp farther in time relative to the reference point.

19. The user interface of claim 13, wherein the second configurable characteristic is indicative of priority.

20. The user interface according to claim 19, wherein a first end of the second axis denotes a lower priority relative to a second end of the second axis.

21. The user interface according to claim 20, wherein the position of the data object relative to the second axis visually indicates a relative priority associated with the data object.

22. The user interface according to claim 21, wherein data objects having a higher priority appear larger than data objects having a relatively lower priority.

23. A data organization system, comprising:
a plurality of data sources containing data files; and
a mobile terminal wirelessly coupled to the data sources and adapted to visually display representations of the data files contained within the data sources in accordance with configurable organization criteria, the mobile terminal having a user interface comprising:
a tab indicative of a category of data files displayed by the user interface;
a first axis extended along a first portion of the user interface to connote a first configurable characteristic;
a second axis extended along a second portion of the user interface to connote a second configurable characteristic; and
a plurality of icons representative of the data files each associated with the data category indicated by the tab, wherein a position of the plurality of icons portrays a level of association between the plurality of icons and the first and second configurable characteristic.

24. The data organization system according to claim 23, wherein the mobile terminal further comprises navigational controls allowing selection of one of the plurality of icons.

25. The data organization system according to claim 24, wherein selecting one of the plurality of icons instantiates a data file exchange with one of the plurality of data sources containing the data file associated with the selected icon.

26. The data organization system according to claim 25, wherein the user interface is adapted to display the contents of the data file exchanged.

27. The data organization system according to claim 26, wherein the contents displayed comprise links to other data files contained within the plurality of data sources.

28. The data organization system according to claim 25, wherein the user interface further comprises a tabular display adapted to organize textual descriptions associated with the plurality of icons in accordance with the first and second configurable characteristic.

29. The data organization system according to claim 28, wherein a row of the tabular display associated with the selected icon is highlighted.

30. A computer-readable medium having instructions stored thereon which are executable by a mobile terminal for placing data objects onto a display of the mobile terminal by performing steps comprising:
extending a first axis along a diagonal portion of the display;
extending a second axis along an orthogonal portion relative to the first axis;
associating first and second data characteristics with the first and second axis; and
locating the data objects on the display, wherein placement of the data objects relative to the position of the first and second axis is indicative of the data objects' relationship to the first and second data characteristic.
